(19) United States
(12) Patent Application Publication
(10) Pub. No.: US 2008/0087815 A1
(43) Pub. Date: Apr. 17, 2008

(54) Time division multiplexing MS with beam converging capillary

(75) Inventors: Harvey Dean Loucks, La Honda, CA (US); James L. Bertsch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Loveland, CO (US)

(21) Appl. No.: 11/549,555

(22) Filed: Oct. 13, 2006

(51) Int. Cl. B01D 59/44

(52) U.S. Cl. 250/287; 250/288

(57) ABSTRACT

A mass spectrometer system includes a first ion source that produces ions in a first ion stream. The mass spectrometer system includes a second ion source that produces ions in a second ion stream. A capillary receives the first and second ion streams and separately introduces ions in the first and second ion streams into a mass spectrometer channel. A mass analyzer is configured to receive and analyze ions from the channel. In one aspect, the capillary introduces ions in the first and second ion streams into the mass spectrometer channel in alternating sequence.

### BACKGROUND OF THE INVENTION

The present invention relates generally to mass spectrometry systems and methods, and more particularly to systems and methods that allow for introducing two or more ion streams into a mass spectrometer channel in an interleaved or time division multiplexed manner.

Combining liquid chromatography (LC) or gas chromatography (GC) with mass spectrometry (MS) is a powerful approach to determining the concentration of target compounds in complex sample matrices. Samples may include biological fluids or environmental samples, among others.

When applying liquid or gas chromatography to a mix of compounds in a sample-containing matrix, the compounds are separated and elute from the chromatography system one after another in either a liquid or gas stream. The liquid or gas stream is then introduced into a mass spectrometer for mass spectrometric analysis. In the mass spectrometer, compounds are ionized with methods known in the art such as atmospheric pressure ionization (API), which is typical for LC/MS systems, and electron Impact Ionization (EII), which is typical for GC/MS systems.

Mass spectrometer analysis can be significantly enhanced by performing two or more stages of mass analysis in tandem (MS/MS). In the most frequently used mode of MS/MS, ions of the target compound having a particular mass-to-charge ratio (m/z) are selected by a first mass analyzer in a first stage of mass analysis from among all the ions of various m/z values formed in the ion source. The selected ions are referred to as precursor ions, and the resulting distribution of ions is called the precursor mass spectrum which is the same spectrum produced in non-tandem instruments.

Between the two stages of analysis, the ions are typically subjected to some mass changing reaction, such as collision-induced dissociation (CID) or collisionally activated dissociation (CAD), so that the succeeding mass analyzer has a different distribution of m/z values to analyze. To that end, the precursor ions are directed into a collision cell where they are energized, typically by collision with a neutral gas molecule, to induce ion dissociation and transition into fragment ions.

In the second stage of mass analysis, the fragment ions and any undissociated precursor ions pass into a second mass analyzer, such as a quadrupole analyzer, ion trap analyzer, time-of-fight analyzer or other analyzer using electromagnetic fields and ion optics. For each of the precursor ion entities, there is a corresponding distribution of reaction product ions called the product ion spectrum. The ions eventually interact with a detector system including signal processing electronics that record an ion mass spectrum at regular time intervals throughout the chromatographic separation. When the ion intensity for all combinations of the precursor and product m/z values is measured, a three dimensional array of data (precursor m/z vs. product m/z vs. intensity), commonly referred to as GC/MS/MS or LC/MS/MS data set, is produced. From each data set, mixtures of ions can be resolved without prior separation of their molecules and a great deal of structural information about individual compounds may be obtained. Tandem MS/MS instruments greatly enhance detection specificity over single-stage mass spectrometers, since ions appearing in a combination of precursor m/z and product m/z values are more specific to a particular analyte than just the precursor m/z value as given in non-tandem instruments.

While the above developments have provided significant advances in mass spectrometry, further improvements are desirable. For example, conventional MS/MS instruments typically cannot keep information about the precursor m/z after the ion is fragmented. Thus, one must fragment ions of only one m/z value at a time, passing the fragments of the selected m/z value ions on to the second stage of mass analysis. Regardless of the type of mass analyzer used for the first stage of MS in an MS/MS experiment, the first stage is used as a mass ‘filter’ in that only ions of a narrow range of m/z values are accepted from the first stage at one time. To obtain the product spectrum from ions that have other m/z values, the experiment must be repeated to produce ions from each different precursor m/z value. To achieve high throughput it is common for many different MS/MS instruments to be present in one laboratory to enable experiments to run on samples for several different target precursor m/z values at once, or more commonly to enable multiple samples to be run simultaneously.

However, acquiring several different MS/MS systems for one laboratory can be very costly. For example, the TOF analyzer is a complex instrument with many costly components such as machine base plates, electronics, vacuum manifolds, vacuum pumps, feedthrough devices, ion transport multiples and pulser and mirror optics. It can also be wasteful to run different samples simultaneously on different machines if some of the ion optic components on the different machines provide identical functions and if the operation lifetimes are relatively long. Thus, it would be desirable to reduce the cost and/or increase the throughput of multiple MS/MS systems. In particular, it would be desirable to provide the analytic capacity of two or more MS/MS systems for less than the cost of two or more MS/MS systems.

### BRIEF SUMMARY OF THE INVENTION

The present invention relates generally to mass spectrometer systems, and more particularly to systems that provide the analytic capabilities of two or more mass spectrometer systems in a single instrument. In certain aspects, systems and methods are provided that that allow for introducing two or more ion streams into a mass spectrometer channel in an interleaved or time division multiplexed manner.

According to an embodiment of the invention, a mass spectrometer system includes a first ion source that produces ions in a first ion stream. The mass spectrometer system includes a second ion source that produces ions in a second ion stream. An ion inlet device including a capillary or tube or orifice receives the first and second ion streams and separately introduces ions in the first and second ion streams into a mass spectrometer channel. A mass analyzer is configured to receive and analyze ions from the channel. In one aspect, the ion inlet device, e.g., capillary or tube, introduces ions in the first and second ion streams into the mass spectrometer channel in alternating sequence.

According to another embodiment of the invention, a mass spectrometer system includes a first ion source that produces ions in a first ion stream. The mass spectrometer system includes a second ion source that produces ions in a second ion stream. An ion inlet device including a capillary or tube or orifice converges ions in the first and second ion streams in an interleaved manner into a single flight path. A first ion guide receives and guides ions in the flight path from the ion inlet device, e.g., capillary. A collision cell receives and dissociates ions in the flight path from the first ion guide. A mass analyzer receives and analyzes the dissociated and undissociated ions in the flight path from the collision cell. In one aspect, a signal processor configured to generate data for the first and second ion streams in a single data file. In another aspect, the mass analyzer is coupled with a demultiplexer configured to convert the single data file into separate data files that correspond with the first and second ion streams.

According to another aspect, a mass spectrometer system is provided that includes a mass analyzer and two or more ion sources. Ion streams produced by the two or more sources are physically combined but electrically pulsed so that the mass spectrum of the two or more ion streams are independently analyzed with the mass analyzer. In certain aspects, the system includes an exit tube coupled with multiple entrance tubes, wherein the ion streams are combined by joining the multiple entrance tubes into the single exit tube. In certain aspects, the system includes one or more voltage sources for controlling the ion sources, wherein a varying voltage turns on and off ion generation by the two or more ion sources and/or ion transmission. In certain aspects, the ion streams are physically joined in a region that has a pressure that is less than the pressure of an ion generation chamber but greater than the pressure of a subsequent vacuum stage.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 shows a mass spectrometer system according to an exemplary embodiment of the invention.

FIG. 2 shows a mass spectrometer system according to another embodiment of the invention.

### DETAILED DESCRIPTION OF THE INVENTION

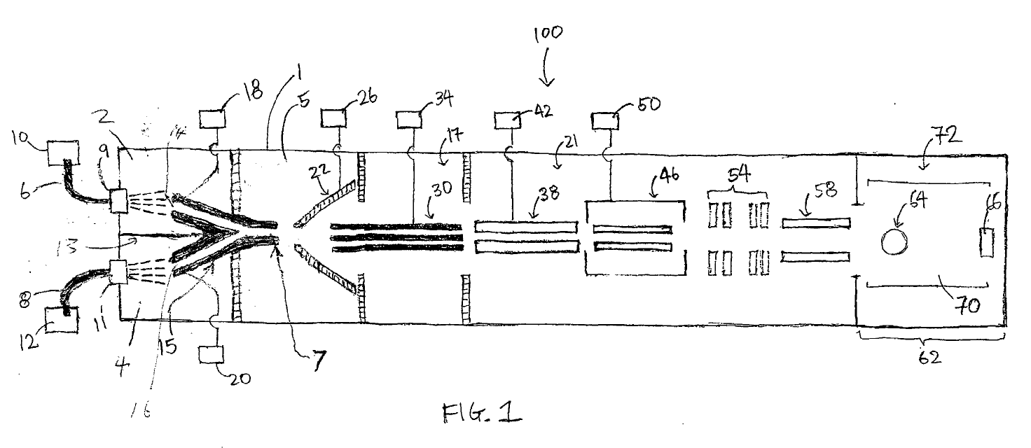

FIG. 1 shows a mass spectrometer system according to one embodiment. The system 100 shown includes a housing structure 1 which either contains or adjoins two or more ion generation regions 2 and 4. The housing 1 defines a chamber 5, within which two or more ion streams are introduced by means of a single entrance 7. Each ion stream is combined or converged into a single flight path with a device 15. The single flight path or ion channel then extends from chamber 5 to an analyzer portion. The ion channel, or Mass Spectrometry (MS) channel, may include various components that control the flight path of ions, such as a first ion guide 30, a collision cell 46, a second ion guide 38 and a mass analyzer 62. In general, a MS channel is defined by the flight path of ions as controlled by the various MS components. As shown in FIG. 1, for example, a first ion stream is introduced by an ion inlet device including a beam converging capillary 15 (or tube or orifice) into the channel from a first ion source 9, and a second ion stream is introduced by beam converging capillary 15 into the channel from a second ion source 11. As will be described in more detail below, two (e.g., first and second ion streams) or more ion streams may be separately introduced into the MS channel in a time division multiplexed manner. The mass analyzer receives and detects the ions and produces a mass spectrum data file representing the combined mass spectrum (e.g., of the first and second ion streams) of the ions in the MS channel. A demultiplexer may be used to process the combined mass spectrum to produce individual mass spectrum files for the individual ion streams.

In one embodiment of the invention, the sample source 10 includes an analytical separation device 6 that provides a liquid containing a sample of interest from to sample sprayer 9. Similarly, sample source 12 may include an analytical separation device 8 that provides a liquid containing a sample of interest to sample sprayer 11. A sample may be any liquid material, including dissolved solids, or mixture of materials dissolved in a solvent. Samples typically contain one or more components of interest, and may be derived from a variety of sources such as foodstuffs or environmental materials, such as waste water, soil or crop. Samples may also include biological samples such as tissue or fluid isolated from a subject (e.g., a plant or animal), including but not limited to plasma, serum, spinal fluid, semen, lymph fluid, external sections of skin, respiratory, intestinal and genitourinary tracts, tears, saliva, milk, blood cells, tumors, organs and also samples of in vitro cell culture constituents, or any biochemical fraction thereof. Useful samples might also include containing calibration standards or reference mass standards.

The analyte sample(s) may be in liquid or gas form, the sprayers 9 & 11 may be merely gas exits, and the ionization method may vary. However, the preferred mode of sample introduction for medium and large molecules in tandem mass spectrometry is liquid chromatography (LC/MS/MS), by which sample components are sorted according to their retention time on a column through which they pass. The various compounds that leave tubes 6 and 8 and flow into sample supply regions 2 and 4 are present for some tens of seconds or less, which is the amount of time available to obtain all the information about an eluting compound. Since compounds often overlap in their elution, rapid spectral generation as provided by LC/MS/MS may enable rapidly generating each compound's elution profile and allow overlapping compounds to be separately identified.

Analytical separation devices 6 and 8 can be any liquid chromatograph (LC) device including but not limited to a high performance liquid chromatograph (HPLC), a micro- or nano-liquid chromatograph, an ultra high pressure liquid chromatography (UHPLC) device, a capillary electrophoresis (CE), or a capillary electrophoresis chromatograph (CEC) device. However, any manual or automated injection or dispensing pump system may be used. For example, in some embodiments, a liquid stream may be provided by means of a nano- or micro-pump.

A continuous stream of sample provided by analytical separation devices 6 and 8 are then ionized by devices 9 and 11, respectively. Devices 9 and 11 may be any ion source known in the art used for generating ions from an analyte sample. Examples include atmospheric pressure ionization (API) sources, such as electrospray (ESI), atmospheric pressure chemical ionization (APCI) and atmospheric pressure photoionization (APPI) sources.

FIG. 1 shows that the ion stream from device 9 is separate from the ion stream from device 11, so that the ions from each source may be independently produced but transferred into the same mass spectrometer system. In one embodiment of the invention, the first ion stream from the first sprayer 9 and second ion stream from the second sprayer 11 are housed in two chambers, 2 and 4, such as shown in FIG. 1. However in another embodiment, a dividing wall 13 is provided to separate the first ion stream from the second ion stream. In another embodiment the separation is maintained by physical space and or electric fields. The ion streams are then joined by a beam converging capillary 15.

Ions leaving sample sprayers 9 and 11 are directed to beam converging transfer capillary 15 which transfers ions toward mass analyzer 62 and allows a reduction of gas pressure from that of the ionization source chambers 2 and 4. Pressure may be reduced by one or more vacuum chambers. Capillary 15 may be a tube, a passageway or any other such device for ion transport and pressure reduction. According to an embodiment of the invention, capillary 15 has a first channel including entrance 14 to transfer the first ion stream from sprayer 9, and a second channel including entrance 16 to transfer the second ion stream from sprayer 11. Ions from the first and second ion streams enter their respective channels of capillary 15 from separate inlets at one end of capillary 15, and exit a single outlet 7 at the other end of capillary 15 to converge into a single flight path. In one aspect, the ion inlet device includes a capillary 15 (or tube) that is Y-shaped as shown.

The mass spectrometer system shown in FIG. 1 further includes chambers 17 and 21. The chambers are separately pumped by vacuum pumps with ions being transported through various vacuum stages of decreasing pressure until the lowest pressure is reached at a mass analyzer 62 (e.g., vacuum chamber 72 in FIG. 1). Typically, while the spray chambers 2 and 4 are held at ambient pressure, vacuum chamber 13 is held at a pressure of about two to two and a half orders of magnitude less than ambient pressure, and mass analyzer 62 is held at a pressure of about six to seven orders of magnitude less than chamber 13. The ions are then swept into vacuum chamber 17 due to the pressure difference between vacuum stage 13 and chamber 17, and due to applied electric potentials.

Ions of the first and second ion streams are combined or converged by capillary 15 into a single flight path in a time division multiplexed manner, e.g., in slots of predetermined time in alternating sequence, as will be further discussed later. The ions in the flight path (including ions from the first and second ion streams) then pass through skimmer 22. FIG. 1 shows skimmer 22 dividing chamber 5 from chamber 17. Skimmer 22 is known in the art to enrich analyte ions relative to neutral molecules such a solvent or gases contained in the ion beams exiting transfer capillary 15 prior to their entries into the ion transfer optics (e.g., an ion guide, ion beam shaping or focusing lenses or the like).

The ions exit skimmer 22 and enter a first or preliminary ion guide 30 in chamber 17. According to an exemplary embodiment of the invention, first ion guide 30 is an octapole ion guide and is driven by power source 34. Ion guide 30 may also be a radio frequency (RF) ion guide or any other type of ion guide such as a direct current (DC) ion guide, a stacked ring ion guide or an ion lens system. Ion guide 30 may also include a multiple structure if the power sources 34 is an RF and/or DC power supplies.

After ions travel along a preliminary ion path through first ion guide 30, they are pushed or directed into a second ion guide 38 in chamber 21. As shown in FIG. 1, second ion guide 38 is driven by power source 42 and may be any of the above types of ion guides. According to an exemplary embodiment of the invention, second ion guide 38 is a quadrupole. Other embodiments of the invention may eliminate an ion guide, such as the first ion guide 30.

FIG. 1 shows a collision cell 46 following second ion guide 38. The ions exiting ion guide 38 are “precursor” ions, and collision cell 46 allows the precursor ions to undergo mass changing reactions (e.g., fragmentation, charge stripping, EDT, m/z changing collisions, etc.) prior to entering a mass analyzer. The precursor ions are energized in collision cell 46 typically by collisions with a neutral gas molecule, such as nitrogen, helium, xenon or argon. The precursor ions are consequently dissociated into fragment ions, having a different distribution of m/z values for the mass analyzer to analyze.

FIG. 1 shows other beam optics 54 that may also be included to refocus the ion beams before they enter a mass analyzer. For example, other beam optics may also include an electric lens having an aperture, or a multiple component beam optics system. The beam optics may also include an ion lens that serves as a refocusing element to direct the ion beam into a mass analyzer. Refocusing may be accomplished by any number of ion lenses known in the art. It may be accomplished, for example, by an aperture lens, a system of aperture lenses, one or more einzel lenses, a dc quadrapole lens system, a multipole lens, a cylinder lens or system thereof, or any combination of the above lenses.

According to one embodiment, mass analyzer 62 is used for analyzing ions from both first and second ion streams of the mass spectrometer system, as combined into a single flight path of ions from ion sources 2 and 4. The fragment ions and any undissociated precursor ions from either the first ion stream from ion source 2 or the second ion stream from ion source 4 pass through beam slicer 58 into mass analyzer 62, which determines the m/z ratio of the ions to determine molecular weights of analytes in the samples.

Tandem mass spectrometers may include multiple mass analyzers operating sequentially in space or a single mass analyzer operating sequentially in time. Mass spectrometers that can be coupled to a gas or liquid chromatograph include the triple quadrupole mass spectrometer, which is widely used for tandem mass spectrometry. However, one limitation in the triple quadrupole system is that recording a fragment mass spectrum can be time consuming because the second mass analyzer must step through many masses to record a complete spectrum. To overcome this limitation, the second mass analyzer may be replaced by a time-of-flight (TOF) analyzer. One advantage of the TOF analyzer is that it can record up to 10⁴ or more complete mass spectra every second. Thus, for applications where a complete mass spectrum of fragment ions is desired, the duty cycle is greatly improved with a TOF mass analyzer and spectra can be acquired more quickly. That is, the TOF analyzer can produce product spectra at such a high rate that the full MS/MS spectrum can be obtained in one slow sweep of the quadrupole mass analyzer. Alternatively, for a given measurement time, spectra can be acquired on a smaller amount of sample.

According to one embodiment of the invention, mass analyzer 62 includes a TOF analyzer. As shown in FIG. 1, TOF analyzer 62 includes pulser 64 and detector 66. Focused ions enter pulser 64, which pulses the ions with a voltage and sends the ions in a flight tube 70 in TOF analyzer 62 until they hit detector 66. In certain aspects, a TOF with an ion mirror may be used, in which case the pulsed ions enter an ion mirror (not shown) and are reflected onto detector 66 at the end of flight tube 70. Since all of the pulsed ions have substantially the same energy, the flight time of ions depends only on their m/z.

Ions have different velocities due to different mass-to-charge ratios (m/z) when accelerated in a vacuum by an electric field. Detector 66 measures the time required for the ion to reach the detector after acceleration begins to determine this velocity at the end of the flight path in flight tube 70. For a known distance d between the acceleration region and the detector, and a flight time t between the times of acceleration and detection, the velocity v will be v=d/t (note that where a TOF includes a mirror element, the equation will differ as is well known to one of skill in the art)(note also that since the pulser does not create an infinite gradient, finite time is spent accelerating and this must also modify the equation). Since the distance is approximately the same for all ions, their arrival times differ with smaller m/z ions reaching the detector first and larger m/z ions later. Signal processing electronics then record an ion mass spectrum at time intervals, in a three-dimensional LC/MS/MS or GC/MS/MS data sets.

According to embodiments of the invention, simultaneous analyses of ions from two or more ion streams is enabled by time division multiplexing. That is, signals from two or more sources are simultaneously sent over one transmission path by interleaving pulses of ions from both sources. As noted above, ions in the ion streams corresponding to ion sources 2 and 4 are transferred into a single flight path in slots of predetermined time, in alternating sequence. Ion sources 9 and 11 may be nebulizers connected to separate nebulizer voltages that produce alternating ion streams in short, rapid pulses by switching nebulizer voltages. Alternatively, the nebulizers may be held at a constant voltage such as ground, the voltage applied to the two entrances 14 and 16 of the capillary 15 may be varied to accept and reject ions from the two sources. Timed spaces may also be provided by switching in neutral molecules (e.g., pure solvent, instead of analyte and solvent solution) into the liquid streams, but this in not preferred because it is inherently slow and disruptive. An electrical means of either inhibiting the ion formation or the ion transport prior to combing the streams is preferred. Interaction between ions from sprayers 9 and 11 may thus be avoided due to the timed spacing of pulses of the ion streams. In one aspect, the length of each pulse occupies the entire ion path from the source to the analyzer. The rest of the ion optics in spectrometer 100 generally operate as components of a single channel MS instrument, except that their operating conditions, such as mass range or filtering, may be additionally adjusted to address the requirements of each ion stream independently.

The mass spectrum is then determined by a signal processing system (not shown). In one aspect, pulser 64 accelerates each ion stream independently, and detector 66 detects each ion signal separately so that two separate data files are instantly produced. In another aspect, the signal processing system records a single output data file for the combined inputs of the first ion stream corresponding to ion source 2 and the second ion stream corresponding to ion source 4. The signal processing system coupled to analyzer 62 includes a demultiplexer that subsequently reassembles the single output data file according to their transmission order, to provide two or more data files corresponding to each ion stream.

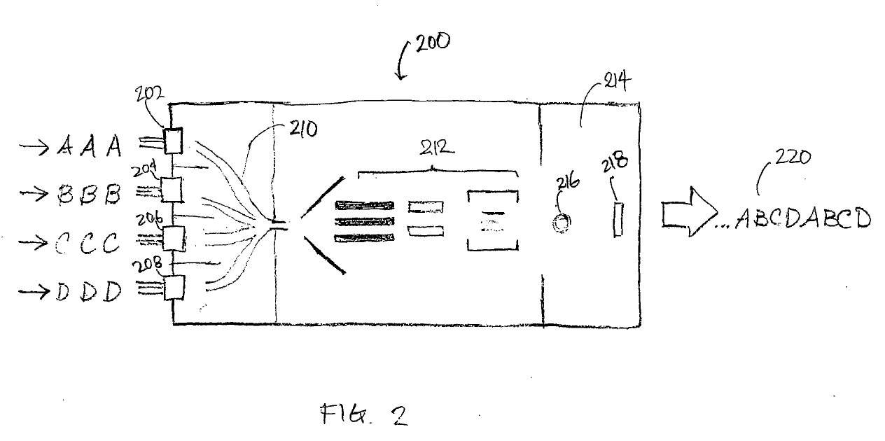

In other embodiments of the invention, three or four different ion streams from three or four different ion sources may be provided in the same MS or MS/MS instrument and share the same TOF analyzer. FIG. 2 shows a simplified schematic of a mass spectrometer 200 according to an embodiment of the invention with multiple input ion streams. Ion streams from ion sources 202, 204, 206 and 208 enter beam converging transfer capillary 210. Ions from ion sources 202, 204, 206 and 208 exit capillary 210 converged onto a single flight path of 212, which includes various ion guides and cells as described above with respect to FIG. 1. The ions then enter mass analyzer 214, which includes pulser 216 and detector 218. The output data 220 is interleaved in a single data file from the combined inputs of 202, 204, 206 and 208 as shown, and subsequently reassembled into separate data files corresponding to each ion source by a demultiplexer.

A variety of different mass analyzers using electromagnetic fields and ion optics may be part of the mass spectrometer system in other embodiments of the invention, such as a quadrupole analyzer, a reflection time of flight analyzer, an ion trap analyzer, an ion cyclotron mass spectrometer, Fourier transform ion cyclotron resonance (FTICR), a single magnetic sector analyzer, and a double focusing two sector mass analyzer having an electric sector and a magnetic sector. Other spectrometry systems and variations as known in the art may be used, such as for example coupling electrospray ionization (ESI) to TOF mass spectrometry (TOFMS). Other variations on the TOFMS include subjecting all the precursor ions to the fragmentation mechanism without preselection and determining the product mass with subsequent acceleration. Recent proposals also include resonant excitation in RF-only quadrupoles for CID with fragment mass analysis by TOFMS.

Embodiments of the invention described above provide for the analysis of two or more ion streams from two or more ion sources using a single instrument. The different ion sources may be different types of sources. Thus, embodiments of the invention provide advantages of two or more mass spectrometry systems in a single chassis, using a single mass analyzer. Providing two or more MS/MS systems associated with different ion streams or ion channels in one instrument saves cost by requiring only a single set of vacuum pumps, ion optics, data acquisition electronics, other hardware and industrial design. Two or more MS/MS systems could be obtained for a reduced cost, e.g., approaching the cost of only one system, or three or four MS/MS systems for the cost of two. Additionally, providing two or more MS/MS channels in one instrument saves the time to run two (or more) different analyses at different times, since the single instrument provides for separate functions while sharing much of the electronics and hardware.

While the present invention has been described with reference to the specific embodiments disclosed, the invention is not limited to any particular implementation disclosed herein. For example, a radio frequency ion guide may be a quadrupole, hexapole or other multipole device, as well as a structure of rings or a multipole sliced into several segments as well known in the art. It should be understood by those skilled in the art that various changes may be made and equivalents substituted without departing from the spirit and scope of the invention. In addition, many modifications may be made to adapt a particular situation, material, composition of matter, process, process steps, to the objective, spirit and scope of the present invention. All such modifications are intended to be within the scope of the claims appended hereto.

What is claimed is:

1. A mass spectrometer system comprising:
a first ion source that produces ions in a first ion stream;
a second ion source that produces ions in a second ion stream;
a capillary that receives the first and second ion streams and separately introduces ions in the first and second ion streams into a mass spectrometer (MS) channel; and
a mass analyzer configured to receive and analyze ions from the MS channel.

2. The mass spectrometer system of claim 1, wherein the capillary introduces ions in the first and second ion streams into the MS channel in alternating sequence.

3. The mass spectrometer system of claim 1, further comprising:
a detector that detects time of arrival of ions in the MS channel; and
a signal processor communicably coupled with the detector and configured to generate data for the first and second ion streams in a single data file.

4. The mass spectrometer system of claim 3, wherein the mass analyzer is coupled with a demultiplexer configured to convert the single data file into a first data file and a second data file that correspond with the first and second ion streams, respectively.

5. The mass spectrometer system of claim 4, wherein the first and second data files include ion mass spectrums.

6. The mass spectrometer system of claim 1, wherein the mass analyzer comprises a pulsing device that receives ions in the MS channel and delivers pulses of ions into a flight tube in ascending order of their atomic mass.

7. The mass spectrometer system of claim 6, wherein the mass analyzer comprises a detector that detects time of arrival of ions in the flight tube.

8. The mass spectrometer system of claim 1, wherein the MS channel includes a first ion guide and wherein the capillary introduces ions in the first and second ion streams into a first ion guide.

9. The mass spectrometer system of claim 8, further comprising a skimmer between the capillary and the first ion guide.

10. The mass spectrometer system of claim 8, wherein the MS channel includes a collision cell that receives ions from the first ion guide, the collision cell being configured to dissociate the ions into ion fragments.

11. The mass spectrometer system of claim 10, wherein the MS channel includes a second ion guide that receives ions from the first ion guide.

12. The mass spectrometer system of claim 11, wherein the MS channel includes a collision cell that receives ions from the second ion guide, the collision cell being configured to dissociate the ions into fragment ions.

13. The mass spectrometer system of claim 10, further comprising a focusing means for focusing the fragment ions and undissociated ions from the collision cell.

14. The mass spectrometer system of claim 13, further comprising a beam slicer that introduces ions from the focusing means into the mass analyzer.

15. The mass spectrometer system of claim 1, further comprising a third ion source that produces ions in a third ion stream, wherein the capillary introduces ions in the third ion stream into the MS channel with the first and second ion streams.

16. A mass spectrometer comprising:
a first ion source that produces ions in a first ion stream;
a second ion source that produces ions in a second ion stream;
a capillary that converges ions in the first and second ion streams in an interleaved manner into a single flight path;
a first ion guide that receives and guides selected ions in the flight path from the capillary;
a collision cell that receives and dissociates ions in the flight path from the first ion guide; and
a mass analyzer that receives and analyzes the dissociated and undissociated ions in the flight path from the collision cell.

17. The mass spectrometer system of claim 1, wherein the capillary introduces ions in the first and second ion streams into the single flight path in alternating sequence.

18. The mass spectrometer system of claim 1, further comprising a signal processor configured to generate data for the first and second ion streams in a single data file.

19. The mass spectrometer system of claim 3, wherein the mass analyzer is coupled with a demultiplexer configured to convert the single data file into separate data files that correspond with the first and second ion streams.

20. The mass spectrometer system of claim 4, wherein the first and second data files include ion mass spectrums.

21. A mass spectrometer system including a mass analyzer and two or more ion sources where ion streams from the two or more sources are physically combined but electrically pulsed so that the mass spectrum of the two or more ion streams are independently analyzed with the mass analyzer.

22. The mass spectrometer system of claim 21, including an exit tube coupled with multiple entrance tubes, wherein the ion streams are combined by joining the multiple entrance tubes into the single exit tube.

23. The mass spectrometer system of claim 21, including one or more voltage sources for controlling the ion sources, wherein a varying voltage turns on and off ion generation by the two or more ion sources.

24. The mass spectrometer system of claim 23, wherein a varying voltage turns on and off ion transmission of the two or more ion streams.

25. The mass spectrometer system of claim 21, wherein the ion streams are physically joined in a region that has a pressure less than the pressure of an ion generation chamber but greater than the pressure of a subsequent vacuum stage.
